(19) United States
(12) Patent Application Publication
(10) Pub. No.: US 2006/0191003 A1
(43) Pub. Date: Aug. 24, 2006

(54) Method of improving security performance in stateful inspection of TCP connections

(76) Inventors: Sae-Woong Bahk, Seocho-Gu (KR); Hyo-Gon Kim, Songpa-Gu (KR); In-Hye Kang, Songpa-Gu (KR)

Correspondence Address: IPLA P.A., 3580 WILSHIRE BLVD., 17TH FLOOR, LOS ANGELES, CA, 90010, US

(21) Appl. No.: 11/129,774

(22) Filed: May 16, 2005

(30) Foreign Application Priority Data
Feb. 18, 2005 (KR) 10-2005-0013414

(51) Int. Cl. G06F 15/16

(52) U.S. Cl. 726/14

(57) ABSTRACT

Disclosed herein is a method of improving a security performance in a stateful inspection of TCP connections. In the security performance improvement method, a stateful inspection computer, placed between first and second hosts in which TCP connections are set up, creates a single session entry corresponding to a new SYN packet whenever the new SYN packet is generated between the first and second hosts. A state of connection progress is updated whenever a packet for a flow between the first and second hosts arrives at the stateful inspection computer. It is determined whether a time required for the updated connection progress has exceeded a predetermined timeout. Further, a session entry in an embryonic connection stage exceeding the timeout is purged. Accordingly, the present invention is advantageous in that it efficiently uses the memory of a stateful inspection computer, maintains lookup performance, and continues stateful inspection even in the face of network attacks, thus improving security performance of the stateful inspection computer.

### BACKGROUND OF THE INVENTION

1. Field of the Invention

The present invention relates, in general, to a method of improving security performance in a stateful inspection of transmission control protocol connections and, more particularly, to a method of improving security performance in a stateful inspection, which sets an optimal timeout to be sufficiently long not to influence the normal operation of legitimate flows in the stateful inspection of transmission control protocol connections, and sufficiently short to minimize the number of session entries generated by abnormal flows, such as attacks, so that stateful inspection continues even in the face of network attacks, thus improving the security performance of a stateful inspection computer.

2. Description of the Related Art

Recently, with the development of the Internet, various types of computers specified for packet processing have been used. Representative of these computers may be a firewall [1], a Virtual Private Network (VPN), a network intrusion detection system, traffic monitoring equipment [2, 3], an accounting and charging system [4] or load balancing equipment [5], in addition to equipment such as a router or switch. As the rate of Internet traffic increases to exceed the rate of Moore's law [6], the load of a packet processing task increases in such a computer, so that the optimization of packet processing is required to improve performance. Therefore, various research into the improvement of the efficiency of functions required for packet processing, such as routing table lookup and packet classification, have been conducted [7, 8 and 9]. However, research into the configuration and management of dynamically allocated memory to execute packet processing is relatively insufficient. Therefore, the present invention handles the issue of configuring and managing dynamically allocated memory in packet processing.

Packet processing in a stateful packet inspection is influenced by previous packets in the same flow, in addition to individual data values of a corresponding packet. Therefore, it is required to maintain information about the states of previous packets in the same flow. For this operation, as a flow is generated or deleted, a corresponding entry is created in or purged from a packet inspection computer. Currently, all of a firewall, a VPN, a network intrusion detection system, traffic monitoring equipment and a usage-based charging system require stateful inspection in different degrees.

Generally, a stateful inspection computer purges invalid entries using a timeout mechanism to improve space utilization and lookup efficiency. However, such a computer only allows a developer to arbitrarily designate a timeout value (typically, a considerably high value, such as 60 seconds or 120 seconds) or allows a user to configure a timeout value, but does not present a systematic guideline for timeout, that is, a guideline based on protocol and traffic analysis [10]. However, the setting of a suitable timeout is necessary for efficient packet processing. First, if a timeout is excessively short, the excessive creation and deletion of entries occurs, thus causing undesirable results. For example, if an entry corresponding to a permitted flow is deleted, a firewall may block a packet even though the packet is legitimate. In contrast, if a timeout is lengthened, an entry in an expired flow is maintained for an unnecessarily long time, thus increasing the amount of memory required [11]. Furthermore, even if a packet inspection computer itself is not a target of network attacks, memory overflow may be caused by the attacks. This is because an IP address or port number continuously changes with respect to each packet in the case of an attack traffic stream, so that packets are recognized to be in different flows from the standpoint of the definition of typical flows. In this case, since each attack packet corresponds to a single flow entry, the amount of memory required to create flow entries rapidly increases in a computer performing a stateful inspection on the traffic.

As described above, conventional research has been concentrated on the reduction of a static table size and the minimization of lookup time for packet classification, not on the management of dynamic memory for a stateful inspection [7, 8 and 9]. In a table used for a stateful inspection employing a session or flow table, only one thesis [2] has mentioned the probability of overflow caused by attacks. However, even this thesis merely mentions that overflow is an element disturbing packet monitoring in high speed links, but research into a method of setting a timeout value is not mentioned. It is possible that a dearth of such research exists because it is difficult to obtain a great number of “typical” Internet traces. That is, in order to set a guideline, a large amount of actual network traffic must be analyzed, and the time for which most TCP connections are set up must be clarified. Therefore, actual systems, such as Cisco, Netscreen or Checkpoint, set a default to a value of at least 60 seconds due to the lack of a guideline [10]. The present invention addresses such a problem first through the analysis of Internet backbone trace of about 1 terabyte capacity, so that it is determined that preceding research addressing the problem scarcely exists.

Dynamic State Management

A stateful packet inspection computer has a list of information about currently tracked flows at an observation location in a network, which is generally designated as a session table. Typically, information about a single flow is composed of a protocol, an origin IP address, an origin port number, a destination IP address, and a destination port number. According to the application, additional information may be required. For example, in the case of a stateful inspection firewall, a TCP sequence number is recorded [1]. A packet inspection computer extracts flow information for each observed packet and compares the flow information with an entry in a session table. If an entry having matching information exists, an action defined in the corresponding entry is performed on the packet. For example, a firewall admits therethrough or blocks a packet, or a usage-based charging system increases a packet or byte count. In contrast, if an entry having matching information does not exist, that is, if a current packet is a start packet of a new flow, a new entry for the flow is created in a session table. Further, if the termination of the flow is observed, a corresponding entry is purged from the session table.

The determination of the start and end of a flow differs according to the protocol used. In a connectionless protocol, such as a User Datagram Protocol (UDP), the end of a flow is determined by means of presumption, strictly speaking. Typically, if a packet for a corresponding flow has not been observed for a predetermined period of time, it is considered that the flow is terminated.

FIG. 1 is a view showing a process of setting up a TCP connection, observed in a packet inspection computer.

A TCP of FIG. 1 is a representative of a connection-oriented protocol. As shown in FIG. 1, TCP connection setup is designated as a 3-way handshake because three packets are exchanged between two hosts [12]. First, in order to initiate connection, host A transmits a SYN packet to the other host B. When receiving the SYN packet from host A, host B transmits a SYN/ACK packet to host A to establish a reverse data channel while transmitting an acknowledgement of the SYN packet. The TCP is a full-duplex protocol, which requires a single data channel in each direction with respect to each connection, so bidirectional synchronization packets are required. Finally, host A transmits an ACK packet that is an acknowledgement of the SYN packet to host B, thus completing the setup of a TCP connection.

It is assumed that a stateful inspection computer is placed at a location on a network through which the connection, formed between hosts A and B, passes (FIG. 1). In this case, a TCP connection setup event can be detected and, additionally, the progress of the connection setup can also be monitored during a 3-way handshake. Further, if a connection setup delay is D_{c}, D_{c}′≈D_{c} is observed, so that the connection setup delay can be measured.

In accordance with the Request For Comments (RFC) 2988 standard [13], if a TCP SYN packet is lost, retransmission is attempted. At this time, a k(≧1)-th retransmission of the SYN packet must be performed within 3×2 ^{(k-1)} seconds after a (k-1)-th retransmission of the SYN packet (according to the definition, the 0-th retransmission is the first transmission of the SYN packet). This is called exponential backoff, which is a kind of congestion control mechanism. If the transmission of the SYN packet successively fails, the time interval between the retransmissions of the SYN packet gradually increases, for example, to 3, 6, 12 and 24 seconds, during the 3-way handshake, so that D_{c}, that is, D_{c}′, increases.

The TCP allows a FIN packet and an ACK packet of the FIN packet to be exchanged to terminate the connection in a manner similar to that of the connection setup. If the exchange of the FIN and ACK packets is performed with respect to both channels, a packet inspection computer purges a corresponding entry from a session table. Further, if a connection is interrupted by a RST packet, a corresponding entry is purged from the session table.

In the stateful inspection computer, the total number of entries in the session table depends on the number of concurrent active flows. In the core part of the. Internet in 2003, it can be observed that at least hundreds of thousands of flows typically and simultaneously pass through a single link. For example, a maximum of 2-37,000 flows were simultaneously observed in a certain OC-48 (2.4 Gbps) link corresponding to an Internet backbone in April, 2003 [11]. Recently, if the fact that an OC-192 (10 Gbps) link is starting to be used in a backbone network is taken into consideration, it can be predicted that several million flows will simultaneously exist in a high speed link in the future.

Analysis of the Influence of Network Attacks

The size of a session table is the multiplication of the number of entries by the size of the entries. If the size of each entry (including two IP addresses, two port numbers, a protocol number and additional overhead for table maintenance) is 40 bytes, the size of a session table in a packet inspection computer having a million entries is 40 Mbytes. Considering the memory capacity of the current computer, the session table having such a size can be sufficiently supported. However, as network attacks are conducted, the number of entries in the session table may explosively increase.

The present invention is focused, among network attacks, on Denial of Service (DoS) attacks and scanning that can influence a stateful inspection, and describes the features thereof.

Table 1(a) shows part of the packet flow (trace) information of a DoS attack observed in an actual backbone [14].

In this case, the host IP of a victim is expressed as “y.y.y.y” to protect the privacy of the victim. Typically, an attacker fixes the host IP address Id of the victim in the case of the DoS attack, while the attacker fills Iₛ, pₛ and p_{d} with randomly generated numbers. The attacker not only does not attempt to connect to the victim, but also randomly selects Iₛ to avoid the tracing of the attacker's IP [15]. For example, because an origin address of “87.231.152.166” shown in Table 1(a) is an address that is not assigned to anyone in the Internet Assigned Numbers Authority (IANA) [16], it can be known that the origin address is an invalid address.

TABLE 1

| | | | | |
|---|---|---|---|---|
| Time | Iₛ | pₛ | I_{d} | p_{d} |

(a) DoS attack

| | | | | |
|---|---|---|---|---|
| . . . | . . . | . . . | . . . | . . . |
| 09:37:03.319081 | 67.171.49.204 | 7804 | y.y.y.y | 16675 |
| 09:37:03.319647 | 20.214.51.196 | 47582 | y.y.y.y | 16675 |
| 09:37:03.319652 | 55.44.55.180 | 61602 | y.y.y.y | 16687 |
| 09:37:03.319922 | 55.44.55.180 | 61602 | y.y.y.y | 16687 |
| 09:37:03.320607 | 89.130.59.164 | 10086 | y.y.y.y | 16695 |
| 09:37:03.321665 | 56.184.129.14 | 4787 | y.y.y.y | 16706 |
| 09:37:03.322084 | 117.152.194.136 | 51005 | y.y.y.y | 16709 |
| 09:37:03.322098 | 3.164.5.250 | 5928 | y.y.y.y | 16716 |
| 09:37:03.322582 | 44.57.134.246 | 58585 | y.y.y.y | 16718 |
| . . . | . . . | . . . | y.y.y.y | . . . |
| 09:37:03.325331 | 25.123.15.210 | 8210 | y.y.y.y | 16736 |
| 09:37:03.326188 | 6.188.152.174 | 23371 | y.y.y.y | 16754 |
| 09:37:03.326565 | 6.188.152.174 | 23371 | y.y.y.y | 16754 |
| 09:37:03.327048 | 87.231.154.166 | 63149 | y.y.y.y | 16768 |
| 09:37:03.327248 | 101.242.222.24 | 18073 | y.y.y.y | 16765 |
| . . . | . . . | . . . | . . . | . . . |

(b) host scan based on Code Red II worm

| | | | | |
|---|---|---|---|---|
| 13:27:35.602109 | x.x.x.x | 2101 | 210.185.103.244 | 80 |
| 13:27:35.602113 | x.x.x.x | 2100 | 210.248.154.32 | 80 |
| 13:27:35.602117 | x.x.x.x | 2102 | 210.175.128.217 | 80 |
| 13:27:35.602122 | x.x.x.x | 2293 | 210.70.243.85 | 80 |
| 13:27:35.602127 | x.x.x.x | 2367 | 210.107.63.78 | 80 |
| 13:27:35.602616 | x.x.x.x | 2378 | 210.78.33.141 | 80 |
| 13:27:35.642113 | x.x.x.x | 2379 | 58.80.253.118 | 80 |
| 13:27:35.692445 | x.x.x.x | 2380 | 210.202.242.119 | 80 |
| 13:27:35.702067 | x.x.x.x | 2108 | 210.78.146.218 | 80 |
| 13:27:35.702071 | x.x.x.x | 2107 | 210.107.216.227 | 80 |
| 13:27:35.702076 | x.x.x.x | 2294 | 210.60.83.150 | 80 |
| 13:27:35.702080 | x.x.x.x | 2105 | 210.133.45.230 | 80 |
| 13:27:35.702084 | x.x.x.x | 2106 | 133.64.252.91 | 80 |
| 13:27:35.702089 | x.x.x.x | 2362 | 210.142.241.241 | 80 |
| 13:27:35.762039 | x.x.x.x | 2381 | 210.20.147.102 | 80 |
| 13:27:35.801651 | x.x.x.x | 2109 | 210.199.26.105 | 80 |
| 13:27:35.801661 | x.x.x.x | 2297 | 210.141.135.151 | 80 |

In a host scan, the host IP address Id of a victim varies according to packet. Typically, a hacker attempts a host scan to detect vulnerability prior to initiating an attack, and conducts a host scan to detect a target host to be infected in the case of a worm. An attacker randomly conducts a scan with respect to an arbitrary range of IP addresses to detect a vulnerable host address. For example, it can be seen that an address of “58.80.253.118”, which is not currently assigned by IANA, appears on part of an actual trace of Code Red II worm shown in Table 1(b).

The packet inspection computer creates a single session entry with respect to each flow, so that separate entries are created even though any one value of flow identifiers Iₛ, pₛ, I_{d} and p_{d}, differs. There is a difference in that Iₛ, I_{d} and p_{d} are changed in a DoS attack, a host scan and a port scan, respectively. That is, because all packets belonging to the same attack do not share the same flow identifier, different session entries are created with respect to individual packets. A more serious problem is that these attacks have a very high probability of creating packets. If several attacks among large-scale attacks having occurred on the Internet are described as examples, this problem is clarified (an extreme example is taken for emphasis). In the case of a DoS attack, as the probability of packet generation increases, attack power can increase. Therefore, referring to a DoS attack on a root Domain Name System (DNS) server occurring in October, 2002, about one hundred thousand to two hundred thousand attack packets per second on a single server were recorded [17]. This example means that, if a certain packet inspection computer is placed near the root DNS server, attack-related entries will be created in a number which is much greater than that of flows that can be typically simultaneously observed in an OC-48 link within several seconds. Even in the case of a host scan, as the rate at which packets are created increases, the infection rate of a worm increases, or a vulnerable host can be detected fast. In the case of a host scan based on the Structured Query Language (SQL) Slammer worm, there was the case in which a single infected host transmitted a maximum of 26,000 packets per second [18]. For example, if the stateful inspection computer is placed at the boundary of an enterprise network including 10 infected hosts, the number of attack-related entries will exceed a million within 4 seconds after the initiation of the attack.

The fact that entries created by attack packets may exist in a session table for a maximum allowable time period further worsens the situation. In a normal TCP flow, a FIN or RST packet is exchanged at the time of termination and is observed, so a corresponding entry can be purged. However, in the case of a DoS attack, since a FIN or RST packet does not exist, an attack-related entry still remains in the session table until it is purged by a timeout. In the case of a host scan, the lifespan of an entry differs according to protocol. If a scanner uses TCP, a scanned host reacts variously according to the scanning technique [19]. For example, if Code Red II succeeds in finding an infectable host, normal connection setup and termination (after the worm is transmitted) are performed, so a corresponding entry is purged from the session table. However, most scan packets are transmitted to an unused IP address, and then a router causes a destination unreachable Internet Control Message Protocol (ICMP) error. A flow entry created by packets causing the ICMP error will not be purged until the stateful inspection computer separately processes an ICMP message for the purpose of purging the entry.

In summary, an entry caused by the attack is created with respect to each attack packet at high speed, and remains in the session table for a long period of time. Since the stateful inspection computer performs session table lookup with respect to each packet, this lookup performance may greatly influence packet throughput of the stateful inspection computer. Since hashing is generally used for the session table lookup, an increase in the number of entries increases the average number of entries per hash bucket, thus decreasing session table lookup speed. Therefore, in order to prevent an increase in the number of unnecessary entries that decrease packet throughput, a method of preventing the creation of incomplete entries occurring due to network attacks is required.

### SUMMARY OF THE INVENTION

Accordingly, the present invention has been made keeping in mind the above problems occurring in the prior art, and an object of the present invention is to provide a method of improving security performance in a stateful inspection, which sets an optimal timeout to be sufficiently long not to influence the normal operation of legitimate flows in the stateful inspection of transmission control protocol connections, and sufficiently short to minimize the number of session entries generated by abnormal flows, such as attacks, so that stateful inspection continues even in the face of network attacks, thus improving the security performance of a stateful inspection computer.

In order to accomplish the above object, the present invention provides a method of improving security performance in a stateful inspection of Transmission Control Protocol (TCP) connections, comprising the steps of a) a stateful inspection computer, placed between first and second hosts in which TCP connections are set Up, creating a single session entry corresponding to a new SYN packet whenever the new SYN packet is generated between the first and second hosts; b) updating a state of connection progress whenever a packet for a flow between the first and second hosts arrives at the stateful inspection computer; c) determining whether a time required for the connection progress updated at step b) has exceeded a predetermined timeout; and d) purging a session entry in an embryonic connection stage exceeding the timeout at step c), wherein the timeout is the sum of a pure connection setup delay that s a time difference between a time when the SYN packet is successfully transmitted by the first host to the second host and a time when a SYN/ACK packet from the second host is received by the first host in response to the successful transmission of the SYN packet, and a SYN packet retransmission delay, occurring as the SYN packet is retransmitted so that the SYN packet is successfully transmitted by the first host to the second host.

Preferably, the session table may be configured so that, if the number of entries in the session table exceeds a predetermined threshold, the pure connection setup delay is decreased and a session entry in the embryonic connection stage is purged, thus decreasing the number of entries in the session table.

Preferably, the pure connection setup delay may be longer than 1 second and shorter than 2 seconds.

Preferably, the SYN packet retransmission may be attempted at intervals based on RFC2988 standard.

Preferably, the session table may be configured so that, if the number of entries in the session table exceeds a predetermined threshold, the number of retransmissions of the SYN packet decreases, and the session entry in the embryonic connection stage is purged, thus decreasing the number of entries in the session table.

Preferably, the SYN packet retransmission may be performed in such a way that the number of attempts to retransmit the SYN packet is 0, and the SYN packet retransmission delay is 0 seconds.

Preferably, the SYN packet retransmission may be performed in such a way that the number of attempts to retransmit the SYN packet is 1, and the SYN packet retransmission delay is 3 seconds.

Preferably, the SYN packet retransmission may be performed in such a way that the number of attempts to retransmit the SYN packet is 2, and the SYN packet retransmission delay is 9 seconds.

### BRIEF DESCRIPTION OF THE DRAWINGS

FIG. 1 is a view showing a process of setting up a TCP connection, observed by a packet inspection computer;

FIG. 2 is a graph showing the cumulative probability distribution of connection setup delays;

FIG. 3 is a graph showing the cumulative distribution of a pure connection setup delay, excluding time delays caused by thee retransmission of a SYN packet;

FIG. 4 is a graph showing the influence of the number of purged entries on the size of a session table when a timeout value is changed; and

FIG. 5 is a graph showing the size of a session table according to a timeout value.

### DESCRIPTION OF THE PREFERRED EMBODIMENTS

Hereinafter, embodiments of the present invention will be described in detail with reference to the attached drawings.

Internet Trace Analysis

How the number of session entries can be explosively increased by attack traffic in a packet inspection computer has been described above. The object of the present invention is to propose a session entry timeout guideline to prevent the explosive increase in the number of entries. A basic approach adopted in the present invention to derive a guideline is described below.

1. A great number of TCP connections are observed on the Internet and a “typical” distribution of a total connection setup delay is obtained.

2. Based on the distribution, a connection setup timeout period sufficient to allow the normal setup of almost all non-attack connections to be completed is selected.

3. Connections that remain incomplete by the timeout are considered as attacks and are purged from a session table. That is, the timeout value derived at (2) is presented as the guideline for the timeout value of an embryonic session entry.

In order to analyze the distribution of the total connection setup delay of (1), a backbone packet trace collected for ten days in December, 2001 was used. The trace was obtained by recording traffic exchanged between two trans-Pacific T3 links for connecting Korea Internet Exchange (KIX), which is one of four Internet exchanges (IXs) in Korea, to the United States. In the trace, only packet headers were collected during an interval ranging from 9 a.m. to 5 p.m. About six billion or more packets were collected everyday, and, on the average, eight million or more TCP connections were derived from a quantity of trace corresponding to one day as a result of the analysis of the packet trace.

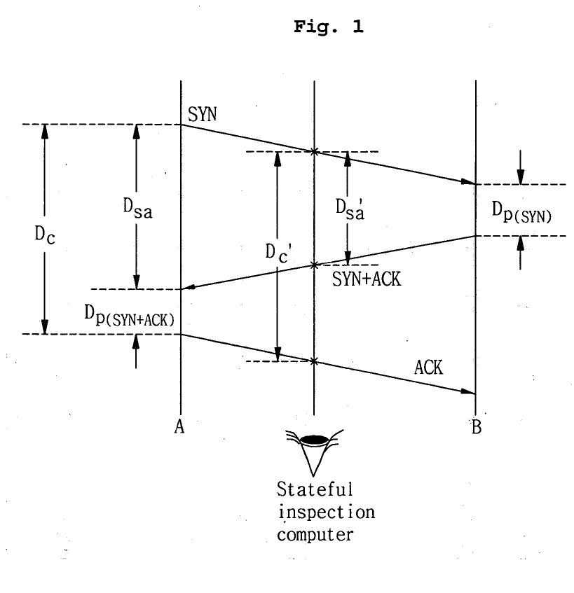

As shown in FIG. 1, the total connection setup delay may be defined as the time between the transmission of a SYN packet and the reception of a corresponding ACK packet.

It is not easy to estimate the time difference Dₛₐ between the transmission of the SYN packet and the reception of the SYN/ACK packet on the basis of the time difference Dₛₐ′ between the transmission of the SYN packet and the reception of SYN/ACK packet that is viewed from the standpoint of an observer placed in the middle of a connection path. In addition, the time difference Dₛₐ cannot be generally considered as a connection setup time. This is because, when asymmetric routing occurs, a SYN/ACK packet corresponding to the SYN packet may be transmitted to another path while deviating from an observation location. In this case, it is impossible for the observer to calculate the time difference between the SYN packet and the SYN/ACK packet. Further, the trace collected in a backbone network is a packet at the intermediate location of the network, so Dₛₐ′≦Dₛₐ is satisfied. This problem becomes serious as the observation location approaches host B. Therefore, the present invention is intended to define a total connection setup delay as the time difference D_{c} between the transmission of the SYN packet and the transmission of the ACK packet, not the time difference Dₛₐ between the transmission of the SYN packet and the reception of the SYN/ACK packet. An approximation value of D_{c} can be obtained by measuring the time difference D_{c}′ between the transmission of the SYN packet and the transmission of the ACK packet that is viewed from the standpoint of the observer (in this case, “approximation value” is used because of a variable delay probability occurring in a network path ranging from host A to the observation location). In an Internet environment operating under asymmetric routing, the usage of the approximation value is more essential. Even if the SYN packet is transmitted by host A to host B while passing through the observation location, the SYN/ACK packet can be received in the opposite direction, that is, through another path. However, if host A transmits the ACK packet, the ACK packet proceeds along the same path as the SYN packet, so that the ACK packet can be observed again and D_{c}′ can be calculated.

The fact that a target trace to be analyzed is obtained by collecting packets crossing the Pacific, that is, long-distance packets, has important meaning. Since all TCP connections recorded in the trace are long-distance connections between Korea and the United States, it can be predicted that the delay and loss rate are relatively high. That is, the observed TCP connection behavior can be considered to be close to the worst situation from the standpoint of the timeout or total connection setup delay. On the basis of this conservative delay estimation value, the timeout value is selected, so the setup of most normal TCP connections is intended to be completed before the timeout.

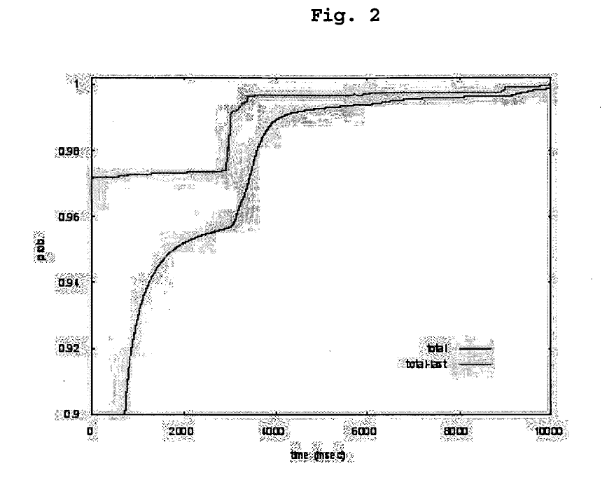

FIG. 2 is a graph showing a Cumulative Distribution Function (CDF) of connection setup delays.

In FIG. 2, the X-axis represents a connection delay time in milliseconds, and the Y-axis represents a cumulative probability. The lower curve tₜₒₜₐₗ represents a total connection setup delay D_{c}′. The total connection setup delay D_{c}′ includes delay times caused by the retransmission of the SYN packet. The upper curve placed above tₜₒₜₐₗ represents the distribution of (tₜₒₜₐₗ−tₗₐₛₜ) where tₗₐₛₜ is the difference between the time when the SYN packet was last transmitted (that is, successfully transmitted) and the time when the SYN/ACK packet is received in response to the SYN packet. That is, the upper curve represents the distribution of time spent in retransmitting the SYN packet, that is, the delays caused by the retransmission of the SYN packet. tₗₐₛₜ denotes a pure connection setup delay, excluding the time delays caused by the retransmission of the SYN packet.

It can be observed from FIG. 2 that curve tₜₒₜₐₗ exhibits, a sharp increase at around 1 second, and also at around 3 seconds. After the second increase, the cumulative probability of connection setup exceeds 99%. If the graph is examined in detail, there is a relatively sharp increase even at around 9 seconds. After this increase, the cumulative probability exceeds 99.5%. Although not easily detected, it can be observed that a relatively sharp increase occurs even at around 6 seconds.

This distribution represents the following important fact. The sharp increase at 3, 6 and 9 seconds is due to the retransmission of the SYN packet.

The time interval between the retransmissions of the SYN packet differs according to the TCP implementation basis. For example, a Berkeley Software Distribution (BSD)-derived implementation retransmits the SYN packet 6 seconds after the first transmission of the SYN packet. Although the time is initially prescribed as 12 seconds, not 6 seconds [15], the time is set to 6 seconds due to a bug in the BSD code. The next retransmission is performed 24 seconds after the previous retransmission of the SYN packet, that is, 30 seconds after the first transmission of the SYN packet. In FIG. 2, difficulty in identifying an increase after 6 seconds means that the BSD-derived TCP implementation is hardly used at the present time.

Recently, most TCP implementations comply with the RFC2988 standard [16]. The first sharp increase at 3 seconds can be described by the initial Retransmission Timeout (RTO) of RFC2988. The minor increase at 9 seconds means a second retransmission (where 9=3+6). It can be seen from the observation that most TCP implementations comply with the RFC2988 standard. Further, in FIG. 2, referring to the delay time caused by the retransmission of the SYN packet, that is, tₜₒₜₐₗ−tₗₐₛₜ, 97% or more of connections do not go through the retransmission of the SYN packet. It can be estimated that only 2% of the connections go through the retransmission of the SYN packet once, and an extremely small part of the connections goes through the retransmission of the SYN packet twice or more.

Another important matter that can be known in FIG. 2 is that tₜₒₜₐₗ, that is, the total connection setup delay D_{c}′, typically does not exceed 1 second. For 1 second, 92% of the TCP connections are completed.

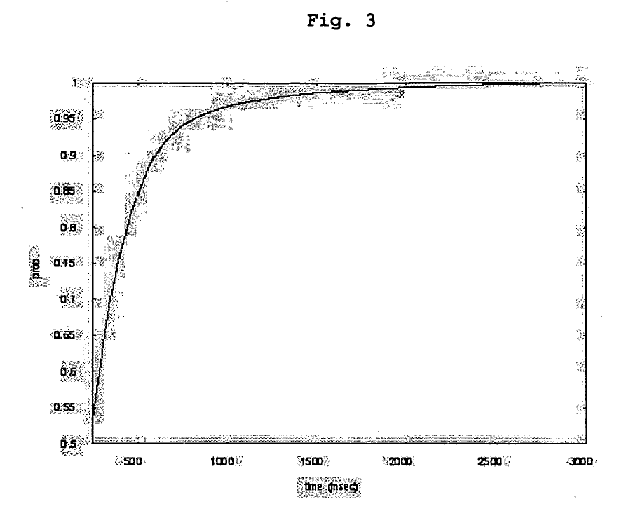

FIG. 3 is a graph showing the cumulative distribution of a pure connection setup delay, excluding time delays caused by the retransmission of a SYN packet, that is, tₗₐₛₜ.

As shown in FIG. 3, a cumulative connection completion rate increases up to 84.58%, 96.71%, 98.59% and 99.33% when tₗₐₛₜ is 0.5, 1, 1.5 and 2 seconds, respectively.

On the basis of the above analysis, the following results are obtained. First, the setup of a great number of connections is completed only when at least 1 second elapses from the first transmission of the SYN packet. If the time is lower than 1 second, the connection setup completion rate decreases remarkably. Second, in the majority of the connections, the round-trip for the exchange of SYN-ACK packets is completed in 2 seconds or less. If the fact that the trace is related to data for long distance connections is considered, the connection setup completion rate will be further increased when tₗₐₛₜ is 2 seconds if statistical data include local (short distance) connections (for example, connections in Korea).

TCP Connection Timeout Guideline

It can be seen that the above-described distribution of TCP connection setup times is greatly influenced by the retransmission behavior of the TCP SYN packet defined in the RFC2988. In the following description, several timeout values are selected and the influences thereof are examined on the basis of the analysis of the distributions in FIGS. 2 and 3 and the RFC2988.

As assumed above, the packet inspection computer creates a single session entry for a new SYN packet. Thereafter, whenever a packet for this flow is received, the progress state of a connection is updated and recorded. After a certain period of time elapses from an initial incomplete state, a corresponding entry is purged. First, on the basis of the observation of FIG. 3, tₗₐₛₜ=1 is set. In order to obtain a higher connection setup completion rate, a timeout value can be increased. However, even if the timeout value is changed to 2 seconds as shown in FIG. 3, the connection completion rate increases by only 2.5%. Further, whenever the timeout value additionally increases by 1 second, more embryonic entries, the number of which corresponds to the number of attack packets per second, are created, so that the attainable profit relative to the resultant risk is very slight.

TABLE 2

| Maximum | | | | |
|---|---|---|---|---|
| allowable | RFC2988-conformant | | BSD-derived | |
| number of SYN | | Completion | | Completion |
| Retransmissions | Timeout | rate | Timeout | rate |
| 0 | 1 s | 93.07% | 1 s | 93.07% |
| 1 | 4 s | 98.92% | 7 s | 99.55% |
| 2 | 10 s | 99.86% | 31 s | 99.99% |
| 3 | 22 s | 99.99% | — | — |

Table 2 is a chart showing the relationship between a connection timeout length and a connection setup completion rate according to the maximum allowable number of SYN packet retransmissions.

Table 2 shows the influence of several timeout values, selected in consideration of the RFC2988 and BSD-derived implementations, on the connection completion rate. The BSD-derived implementation allows a total of three retransmissions of the SYN packet because a connection setup timer expires at 75 seconds, that is, 3 seconds before the fourth retransmission of the SYN packet. Regardless of the RFC2988 or BSD, the connection completion rate is close to 1 when the timeout value τ=10. Further, when 4≦τ≦10 is given, only a slight variation is exhibited. For example, if τ is changed from 4 to 7, that is, even if one retransmission of the SYN packet is allowed with respect to a BSD-derived system, the connection completion rate increases by only 0.57% for the additional 3 seconds. In contrast, as shown in FIG. 2, if τ is lower than 1, there is a very undesirable effect on connection setup. The guideline for the connection setup timeout values obtained through the analysis is described below.

If it is assumed that R is a delay caused by the retransmission of the SYN packet, and T is a pure connection setup delay, the timeout value is designated as (R+T), where it is preferable that 0, 3 or 9 be selected as R according to the allowable number of retransmissions of the SYN packet, and one of values, satisfying 1≦T≦2, be selected as T according to a desired trip delay.

For example, a default timeout can be set to 4 (that is, R=3 and T=1). Under this guideline, the stateful packet inspection computer can increase the timeout value until a given target completion rate is achieved. In contrast, if the utilization level of dynamic memory exceeds a threshold, the timeout value can be decreased so that the utilization level decreases below the threshold.

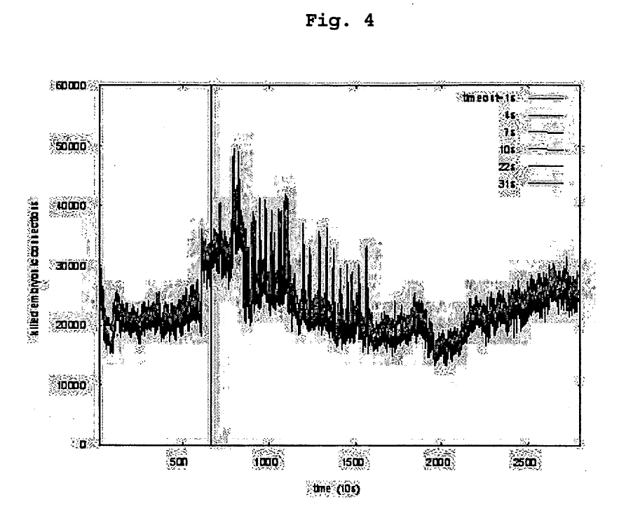

FIG. 4 is a graph showing the influence of the number of purged entries on the size of a session table when a timeout value is changed.

In order to obtain the graph of FIG. 4, a session table is periodically examined, entries, existing in embryonic connection stages after timeout, are purged, and the number of purged entries is recorded. Sharp spikes of FIG. 4 are DoS attack attempts. The remaining parts thereof can be considered as normal traffic and scan traffic (in the trace, weak DoS attacks and scan traffic are observed almost every minute [17]). In FIG. 4, it can be observed that, as the timeout value increases, the number of purged connections decreases, so that the setup of more connections is completed, but, if the number of connections that have been completely set up and the absolute number of purged connections are compared to each other, the difference therebetween is not high. The reason for this is that an increase in the connection completion rate is slight even if a timeout is lengthened after 1 second, as shown in Table 1. That is, FIG. 4 shows that, although τ is increased, most purged embryonic entries do not consequently reach a connection completion state.

In contrast, the required size of a session table varies with the value of τ.

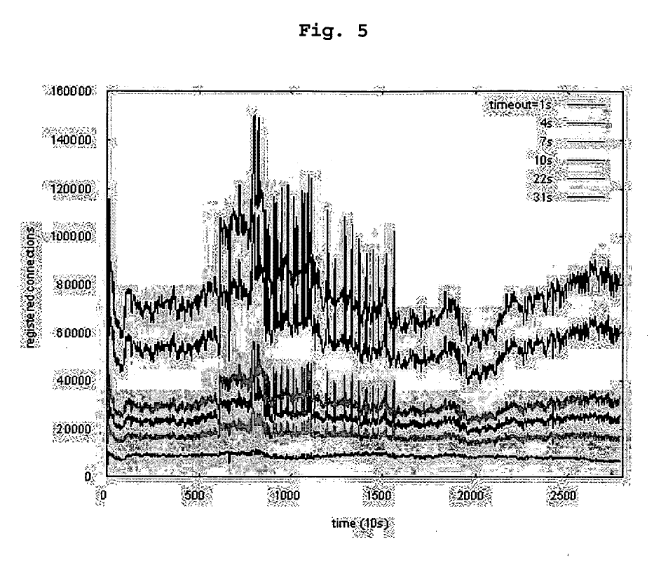

FIG. 5 is a graph showing the size of a session table according to a timeout value.

Respective curves, indicated sequentially in an upward direction in FIG. 5, represent the sizes of the session table according to times observed while τ is changed to 1, 4, 7, 10, 22 and 31, respectively. In the worst case, when τ is 31, the number of entries is 14 times the value obtained when τ is 1, and is 6 times the value obtained when τ is 4. Therefore, it can be seen that lower τ values are more resistant to attack traffic. In other words, a DoS attack more strongly influences the inspection computer as the timeout is lengthened. The reason for this is that the number of entries in the session table is proportional to the value of τ and is also proportional to the strength of an attack. That is, if it is assumed that xₜ is the number of legitimate connection entries at time t, and λ is an attack rate, the total number of entries cₜ existing in the session table at time t is expressed by the following Equation [1],
cₜ(τ)=xₜ+λτ [1]

In this case, it is difficult to define xₜ as a function of τ. That is, the timeout value τ does not influence the number of legitimate connection entries, because most legitimate connections are set up before the timeout, as shown in Table 1. A second term on the right side of Equation [1] has a value other than 0 only when there is an attack.

On the basis of Equation [1] and FIG. 5, the rate of an attack flow occupied in the session table can be estimated. For example, in FIG. 5, when t=800, the DoS attack is activated. At this time, if cₜ(1)≈10,000 and cₜ(10)≈55,000 given in FIG. 5 are applied to Equation [1], simultaneous equations can be obtained as indicated by Equation [2].
xₜ+λ=10,000
xₜ+10λ=55,000 [2]

If the simultaneous equations are solved, xₜ=λ=5,000 is obtained. This means that the number of entries caused by attacks is 5,000 (=λτ) and occupies half of the session table even at τ=1. If xₜ=λ=5,000 and τ=31 are applied to Equation [1], cₜ(31)=160,000 is obtained in which about 3% error exists between the actual measurement value and the obtained value. The estimated number of entries purged for 10 seconds at t=800 is 10λ=50,000, which is almost identical to the measurement value of FIG. 4.

The strength of an attack is relatively low in the present trace. Even in the case of the strongest attack, an attack rate does not exceed 5,000 packets per second [17]. However, if a host is exposed to a full-fledged distribution DoS attack or large-scale worm epidemic traffic, the size of the session table may be uncontrollably increased. For example, if there are 10 infected hosts struck by 26,000 attack packets per second as in the case of the SQL Slammer infection, 26 million attack entries occupy the session table when τ=100. The gist intended to be described here is as follows. If the embryonic state of TCP flows is allowed to be longer to increase a connection setup completion rate, a stateful packet inspection computer is at risk of memory exhaustion and lookup performance deterioration without actually increasing the connection setup completion rate. Therefore, if the embryonic state of connection setup continues for 4 or 10 seconds, which is the timeout recommended in the embodiments of the present invention, or longer, it is preferable to immediately purge the embryonic connection.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### REFERENCES

[1] Stateful-inspection firewalls: The Netscreen way, white paper, http://www.netscreen.com/products/firewall_wpaper.html.

[2] G. Iannaconne, C. Diot, I. Graham, N. McKeown, “Dealing with high speed links and other measurement challenges,” Proceedings of ACM Siacom Internet Measurement Workshop, 2001.

[3] K. Claffy, G. Polyzos, and H.-W. Braun, “A parametrizable methodology for Internet traffic flow monitoring,” IEEE JSAC 8(13), October 1995, pp. 1481-1494.

[4] H.-W. Braun, K. Claffy, and G. Polyzos, “A framework for flow-based accounting on the Internet,” Proceedings of IEEE Singapore International Conference on Information Engineering, 1993. pp. 847-851.

[5] V. Srinivasan, G. Varghese, S. Suri, M. Waldvogel, “Fast Scalable Algorithms for Level Four Switching,” Proceedings of ACM Sigcomm, 1998.

[6] L. G. Roberts, “Beyond Moore's Law: Internet Growth Trends,” IEEE Computer, 33 (1), January 2000, Page(s): 117 -119

[7] P. Gupta and N. McKewon, “Packet classification on multiple fields,” Proceedings of ACM Sigcomm, 1999.

[8] F. Baboescu and G. Varghese, “Scalable packet classification,” Proceedings of ACM Sigcomm, 2001.

[9] S. Singh, F. Baboescu, G. Varghese and J. Wang, “Packet Classification Using Multidimensional Cuts,” Proceedings of ACM Sigcomm 2003.

[10] Gill, “Maximizing firewall availability,” http://www.qorbit.net/documents/maximizing-firewall-availability.htm.

[11] IP Monitoring Project at Sprint, http://ipmon.sprint.com/ipmon.php.

[12] R. Stevens, TCP/IP Illustrated Vol. 1. Addison-Wesley, 1994.

[13] V. Paxson and M. Allman, Computing TCP's retransmission timer, RFC 2988, November 2000.

[14] H. Kim, “Dynamic memory management for packet inspection computers,” techreport, http://ubiquitous.korea.ac.kr/lifetime.html.

[15] K. Houle and G. Weaver, “Trends in denial of service attack technology,” a CERT paper, http://www.cert.org/archive/pdf/DoS._trends.pdf, October 2001.

[16] IANA, “Internet protocol V4 address space,” http://www.iana.org/assignments/ipv4-address-space.

[17] P. Vixie (ISC), G. Sneeringer (UMD), and M. Schleifer (Cogent). Events of 21 Oct. 2002. Nov. 24, 2002

[18] D. Moore et al., “The spread of Sapphire worm,” techreport, http://www.caida.org/outreach/papers/2003/sapphire/sapphire.html, February 2003.

[19] M. de Vivo, E. Carrasco, G. Isern, and G. de Vivo, “A review of port scanning techniques,” ACM Computer Communication Review, 29(2), April 1999.

[20] NLANR, “NLANR network traffic packet header traces,” http://pma.nlanr.net/Traces/.

As described above, the present invention provides a method of improving security performance in a stateful inspection of TCP connections, which sets an optimal timeout value for TCP connections between hosts, so that the memory of a stateful inspection computer is efficiently used, lookup performance is maintained, arid stateful inspection continues functioning even in the face of network attacks, thus improving security performance of the stateful inspection computer.

What is claimed is:

1. A method of improving security performance in a stateful inspection of Transmission Control Protocol (TCP) connections, comprising the steps of:
a) a stateful inspection computer, placed between first and second hosts in which TCP connections are set up, creating a single session entry corresponding to a new SYN packet whenever the new SYN packet is generated between the first and second hosts;
b) updating a state of connection progress whenever a packet for a flow between the first and second hosts arrives at the stateful inspection computer;
c) determining whether a time required for the connection progress updated at step b) has exceeded a predetermined timeout; and
d) purging a session entry in an embryonic connection stage exceeding the timeout at step c),
wherein the timeout is the sum of a pure connection setup delay that is a time difference between a time when the SYN packet is successfully transmitted by the first host to the second host and a time when a SYN/ACK packet from the second host is received by the first host in response to the successful transmission of the SYN packet, and a SYN packet retransmission delay, occurring as the SYN-packet is retransmitted so that the SYN packet is successfully transmitted by the first host to the second host.

2. The security performance improvement method according to claim 1, wherein the session table is configured so that, if the number of entries in the session table exceeds a predetermined threshold, the pure connection setup delay is decreased and a session entry in the embryonic connection stage is purged, thus decreasing the number of entries in the session table.

3. The security performance improvement method according to claim 1, wherein the pure connection setup delay is longer than 1 second and shorter than 2 seconds.

4. The security performance improvement method according to claim 1, wherein the SYN packet retransmission is attempted at intervals based on RFC2988 standard.

5. The security performance improvement method according to claim 4, wherein the session table is configured so that, if the number of entries in the session table exceeds a predetermined threshold, the number of retransmissions of the SYN packet decreases, and the session entry in the embryonic connection stage is purged, thus decreasing the number of entries in the session table.

6. The security performance improvement method according to claim 4, wherein the SYN packet retransmission is performed in such a way that the number of attempts to retransmit the SYN packet is 0, and the SYN packet retransmission delay is 0 seconds.

7. The security performance improvement method according to claim 4, wherein the SYN packet retransmission is performed in such a way that the number of attempts to retransmit the SYN packet is 1, and the SYN packet retransmission delay is 3 seconds.

8. The security performance improvement method according to claim 4, wherein the SYN packet retransmission is performed in such a way that the number of attempts to retransmit the SYN packet is 2, and the SYN packet retransmission delay is 9 seconds.
